(19) United States
(12) Patent Application Publication
(10) Pub. No.: US 2013/0330443 A1
(43) Pub. Date: Dec. 12, 2013

(54) FOOD PRODUCT

(71) Applicants: Robert Napoletano, Newtown Square, PA (US); Matthew Medici, Springfield, PA (US); David Preston, Springfield, PA (US); Brett Waddington, Springfield, PA (US)

(72) Inventors: Robert Napoletano, Newtown Square, PA (US); Matthew Medici, Springfield, PA (US); David Preston, Springfield, PA (US); Brett Waddington, Springfield, PA (US)

(73) Assignee: Davey Foods LLC, Newtown Square, PA (US)

(21) Appl. No.: 13/493,335

(22) Filed: Jun. 11, 2012

(51) Int. Cl. A23L 1/314; A23L 1/315; A23L 1/317

(52) U.S. Cl. 426/92; 426/282

(57) ABSTRACT

A food product is provided. Methods of making a food product are provided.

### FIELD OF INVENTION

The present invention is directed generally to a combination food product, in particular, a food product having multiple layers of meats and cheese, providing for a convenient snack food.

### BACKGROUND

Combination food products (e.g., food products having combined ingredients) allow a person to enjoy several flavors at once. In combining ingredients to make a combination food product, it may be significant: that the different ingredients or combined foods compliment each other; are prepared in such as way that there is a suitable blend of tastes; that the different ingredients or combined foods are provided in a neat (non-messy) and/or self-contained arrangement, whereby a person can eat the combination food product without fear of having the combination food product fall apart; and, that the combination food product can be eaten in a setting where personal space is an issue. These are just some concerns facing a combination food product.

Generally, when attending an event such as a sports event, it is often preferred to have a food product that is a combination of foods that is somewhat self-contained and not especially untidy, since a person is not eating the food in a restaurant, or the privacy and relaxed atmosphere of their own home. For example, a person at an event such as a baseball game will have limited seating space, and will have other people around them in close proximity. It is important, then, that any combination food product does not fall apart, making for a mess and a loss of the food product. If a food product falls apart, it will create a mess, an inconvenience, and could result in a loss of the actual food product. Particularly for a combination food product where tasting all of the parts of the combined product together adds to the enjoyment of the food product, it is important that a combination food product stays together to maximize a person's eating pleasure.

### SUMMARY

In an aspect, the invention relates to a food product comprising a base meat having a cavity formed therein to receive at least one piece of cheese. At least one piece of cheese is positioned within the cavity. It is preferred that the piece of cheese is located completely within the cavity. An intermediate meat is provided having a selected thickness, and the intermediate meat sized and configured to substantially cover the cavity in order to maintain the piece of cheese within the cavity. A outer meat is wrapped around the base meat and the intermediate meat. It is preferred that the outer meat substantially covers substantially the entire surface of the intermediate meat and the base meat.

In another aspect of the invention, the invention relates to a method of assembling a food product comprising: forming a cavity in a base meat, positioning at least one piece of cheese completely within the cavity, selecting a intermediate meat, the intermediate meat sized and configured to substantially cover the cavity in order to maintain the piece of cheese within the cavity, positioning the intermediate meat over the base meat and the cavity in order to substantially cover the cavity, and covering the entire surface of the base meat and the intermediate meat with a outer meat. The food product is then cooked (cooked and/or fried) as described herein.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1A illustrates an embodiment of the invention showing a base meat with a cavity formed in the base meat.

FIG. 1B illustrates an embodiment of the invention showing a base meat with multiple sticks of cheese positioned in the cavity. The food is in an uncooked state.

FIG. 1C illustrates an embodiment of the invention showing an intermediate meat positioned to cover the cavity.

FIG. 1D illustrates an embodiment of the invention showing a contact zone adjacent to the cavity.

FIG. 2A illustrates an embodiment of the invention showing an example of an outer meat positioned for wrapping about the base meat, cheese and intermediate meat.

FIG. 2B illustrates an embodiment of the invention showing an example of a first outer meat wrapped about the base meat, cheese and intermediate meat.

FIG. 2C illustrates an embodiment of the invention showing an example of the first outer meat and a second outer meat wrapped about the base meat, cheese and intermediate meat.

FIG. 3A illustrates an embodiment of the invention showing a side view of an example of a food product.

FIG. 3B illustrates an embodiment of the invention showing an end view of an example of the food product.

FIG. 3C illustrates an embodiment of the invention showing a cross-section view of an example of the food product.

FIG. 4A illustrates an embodiment of the invention showing a side view of an example of a cooked, then fried food product.

FIG. 4B illustrates an embodiment of the invention showing an end view of an example of the cooked, then fried food product.

FIG. 4C illustrates an embodiment of the invention showing a cross-section view of an example of the cooked, then fried food product.

FIG. 5A illustrates an embodiment of the invention showing an inner cross-section view of an example of the cooked, then fried food product.

FIG. 5B illustrates an embodiment of the invention showing an example of the cooked, then fried food product and a bread.

FIG. 6 illustrates an embodiment of the invention showing a method of making a food product.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

A food product according to an embodiment of the invention generally comprising a base meat with a cavity formed therein, at least one piece of cheese placed substantially completely within the cavity, a intermediate meat covering the base meat, the cavity, and the piece of cheese, and a outer meat substantially covering the intermediate meat, the piece of cheese and the base meat.

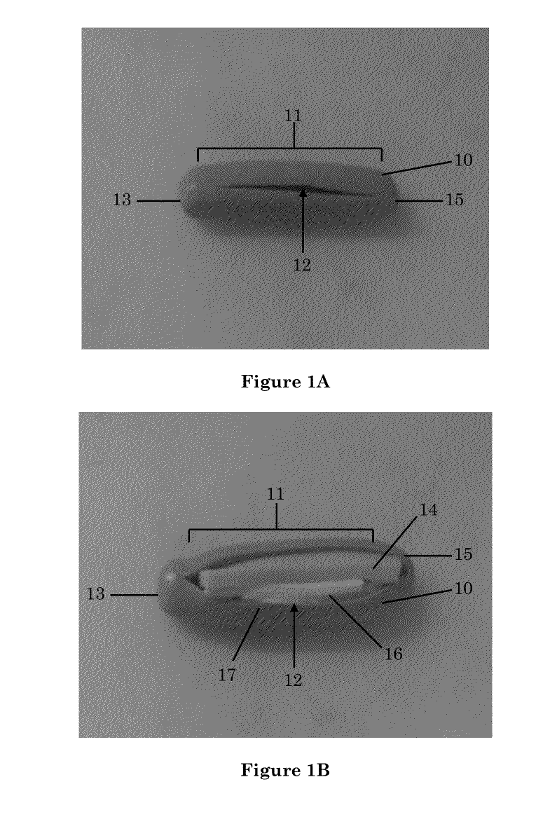

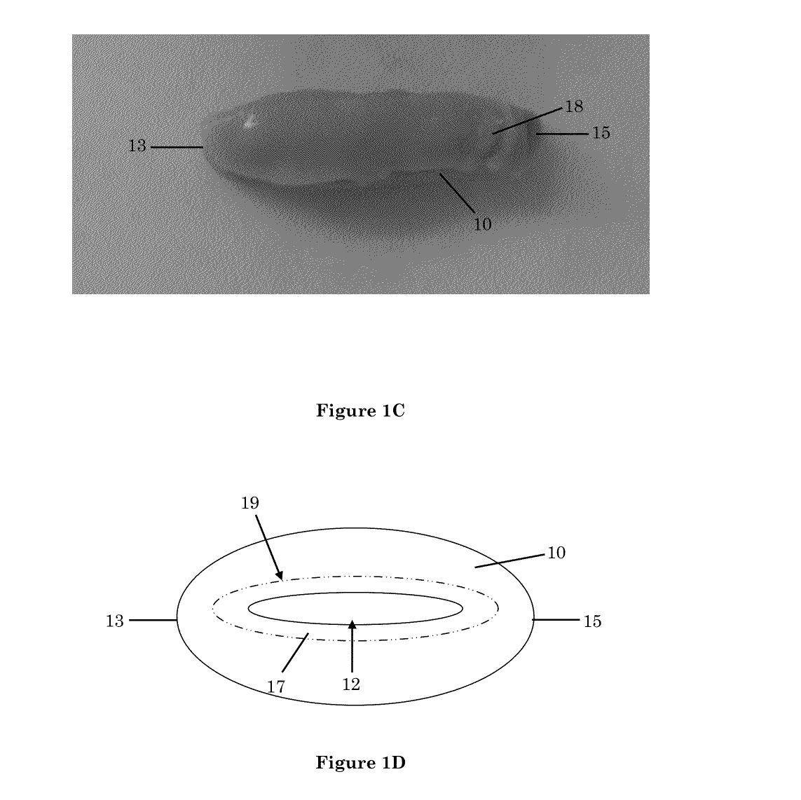

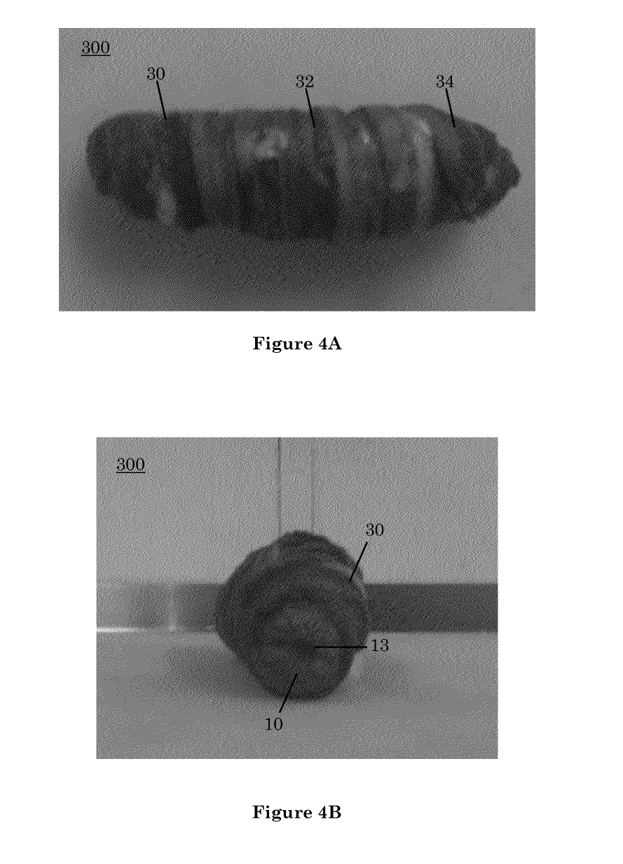

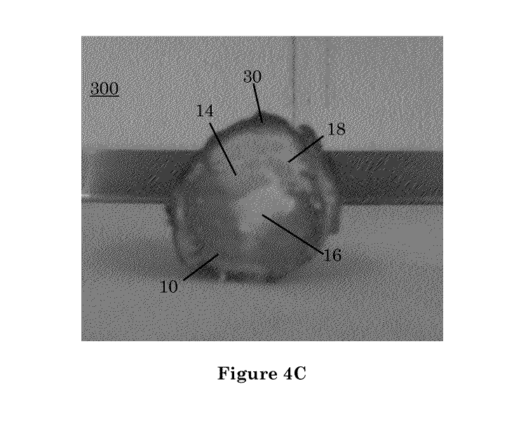

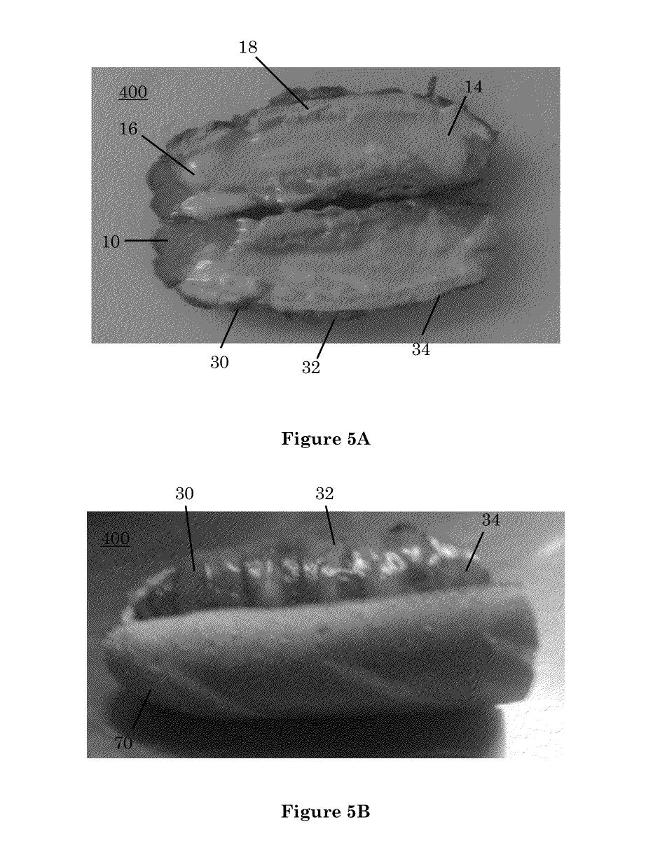

In FIGS. 1A-3C, the food product is shown in an uncooked state. In FIGS. 4A-5B, the food product is shown in a cooked state.

Referring to FIG. 1A, a base meat 10 is illustrated with a cavity 12. The base meat 10 may be any meat. For example, the base meat 10 may be any hot dog, any kielbasa, any bratwurst, any sausage, steak or chicken. The base meat 10 may be any acceptable or shape. It is preferred that the base meat 10 has an oblong shape, such as a hot dog or sausage, having a generally cylindrical body 11 and rounded ends 13, 15. For example, the base meat 10 may be a standard hot dog measuring, for example, 1 inch in diameter×6.8 inches in length. Any length oblong meat is acceptable. Base meat may be one or a combination of meats.

In a preferred embodiment, the base meat 10 is an oblong meat, such as, for example, a hot dog, kielbasa, a bratwurst, or a sausage. A hot dog 10 is shown in the Figures for illustration purposes as the base meat to illustrate an embodiment of the invention. However, those of skill in the art will appreciate that any meat product sized and shaped for the purposes described herein may be used as an alternative to a hot dog.

A cavity 12 is formed in the base meat 10. The cavity 12 may preferably be formed by slicing open the base meat 10, or by any other acceptable method for creating a cavity in a meat product. For example, rather than providing a slice in the base meat 10, a chunk or portion of the base meat may be cut and/or otherwise removed. Or, a cavity can be formed by boring a hole in the base meat. Additionally, if the meat is a meat that can be shaped, processed or prepared in a particular shape, the base meat 10 may be pre-formed having a cavity in it having the properties of the cavity described herein. The cavity 12 preferably extends along the length of the base meat 10, preferably extending almost to the ends of the base meat 10.

Referring to FIG. 1B, the cavity 12 in the base meat 10 is sized and shaped so that the cavity 12 is capable of receiving at least one piece of cheese 14, and in a preferred embodiment, a stick of cheese 14 is used. The Figures show an illustrative embodiment with two sticks 14, 16 of cheese, each stick of cheese 14, 16 being a different type of cheese. Cheese sticks such as the stick of cheese 14 are available from several companies, providing for a portion of cheese that has been preformed in a convenient size and shape. It is preferred that such a cheese stick is made or selected so that it fits in the cavity 12. Certain cheese products are now offered pre-packaged as rectangular cheese sticks or cylindrical cheese sticks, and such products may be used as the piece of cheese described herein. The at least one piece of cheese may be one or a combination of cheeses.

The piece of cheese 14 may be placed inside the cavity 12 of the base meat 10. It is preferred that the cavity 12 extend longitudinally along a length of the base meat 10 body 11, from adjacent a first end 13 of the base meat and extending to adjacent a second end 15 of the base meat 10 body 11. Preferably, the cavity 12 does not reach to the ends of the base meat 10, instead ending about 0.2 inches to about 2 inches from either end of the base meat. This may allow base meat 10 to generally maintain its shape without splitting completely in half.

It is appreciated that, although in a one embodiment a stick of cheese is described, any types of pieces or chunks of cheese may-be used to fill the cavity 12 with cheese. Crumbled cheese, cheese blocks, cheese pieces, or cheese slices, may all be used to fill the cavity. If a soft cheese or “spray-able” cheese is used, the soft cheese may be squirted, sprayed, spread, injected, infused, squeezed or otherwise deposited into the cavity 12. The cheese, whether one or a plurality of cheeses, should preferably fit at least mostly within the space of the cavity 12. At least a portion of the cheese should be positioned within the cavity. Some of the cheese may extend beyond or protrude from the cavity. The piece of cheese may alternately be positioned so that most of the piece of cheese is positioned within the cavity, so that at least half of the piece of cheese is positioned within the cavity, or so that less than half of the piece of cheese is positioned within the cavity.

The piece of cheese 14 may be any selected cheese type. One or a plurality of cheese sticks (or pieces or slices of cheese) may be used, depending on preference, and more than one type of cheese may be used to add to the flavor of the combination food product. The piece of cheese 14 may include more than one cheese type. For example, a first piece of cheese 14 may be a stick of cheddar cheese and a second piece of cheese 16 may be a stick of American cheese. The piece or stick of cheese may be any size. For example, piece of cheese 14 may be a 0.5 oz. cheese stick.

An intermediate meat 18 is used to provide a cover for the cavity 12, thereby substantially enclosing the piece of cheese 14 positioned at least partially within the cavity 12. Referring to FIG. 1C, the intermediate meat 18 may be configured to substantially cover the cavity 12 of the base meat 10, and will preferably act to maintain the piece of cheese 14 within the cavity. It is preferred that the intermediate meat 18 cover the cavity 12 in such a manner that the intermediate meat 18 both encloses the piece of cheese 14 located within the cavity 12, and also contacts the base meat 10 along an area 17, for example shown in FIG. 1B, surrounding the cavity 12. In this manner, the piece of cheese 14 will be maintained within the cavity during processing and eating, as described in greater detail herein.

The intermediate meat 18 may be any meat, but is preferably a meat having a thickness and suppleness that permits it to be sized and/or shaped to be placed over and cover the cavity. The intermediate meat may be a combination of one or more meats. The intermediate meat 18, in an example, is preferably a chicken cutlet 18 or portion of a chicken cutlet sliced thin so that it can be shaped and positioned as described. For example, the intermediate meat 18 may be a piece of chicken cutlet 18, for example an approximately 1.5 oz. piece of chicken cutlet, placed on the base meat 10 to encase the piece of cheese 14 and substantially cover the cavity 12 and contact the base meat 10 along at least a portion of, or entirely along, the area 17 adjacent the cavity 12, designated as a contact zone 19. FIG. 1D shows an exemplary schematic of a contact zone adjacent the cavity. In an embodiment, the intermediate meat 18 completely covers the cavity 12. The chicken may be pounded out to thin the chicken cutlet without losing volume, making it approximately 3-4 cm thick and approximately 6 inches in length. The chicken 18 may be placed on the base meat, encasing the piece of cheese 14 in the base meat. It is appreciated that a combination chicken product, or a product containing at least some chicken, can be used as the intermediate meat.

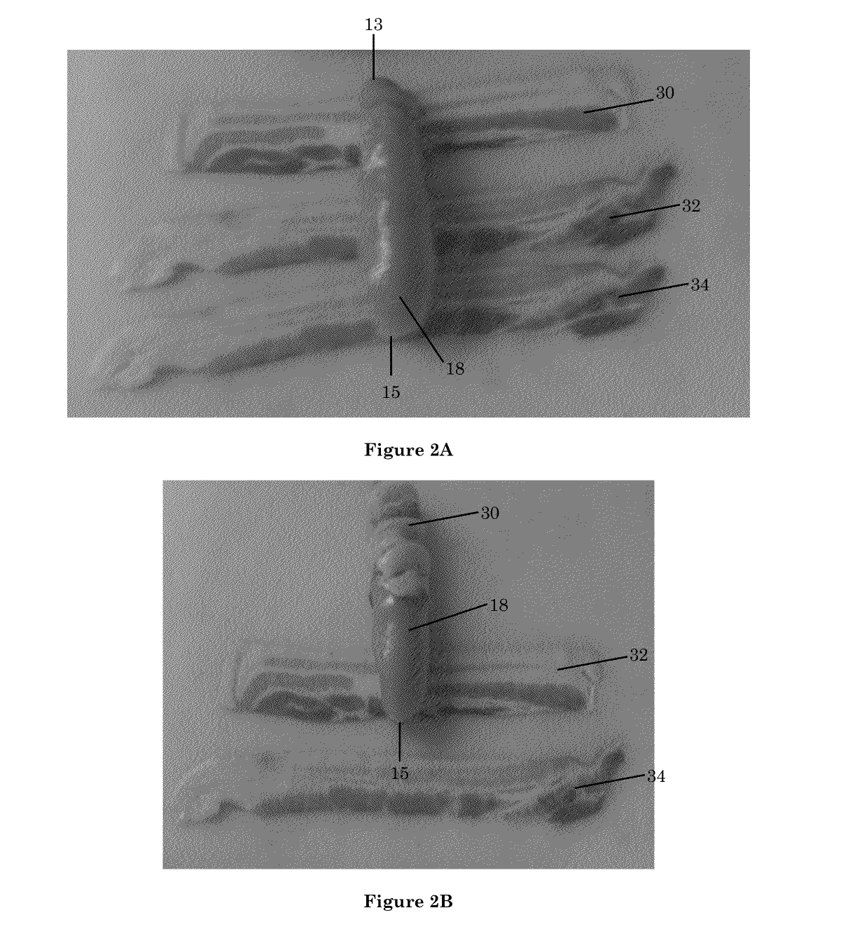

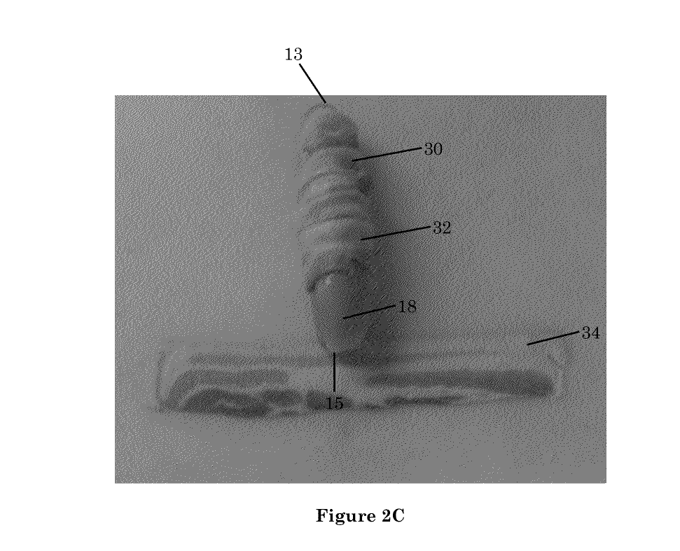

Referring to FIG. 2A, an outer meat 30 is wrapped around the base meat 10 and the intermediate meat 18. It is preferred that the outer meat 30 is selected from the group of meats that are thinly sliced and can be draped over, encircled about, or wrapped around, the base meat 10 and the intermediate meat 18, such as, by way of example, bacon, sliced lunchmeats (bologna, ham, salami), prosciutto, pepperoni, chip steak, sandwich steak, chip chicken steak, pancetta. These types of meats, as well as other meats not specifically named but sharing similar characteristics, have the attribute that they can be readily wrapped around the base meat and intermediate meat to provide an outer layer that holds and/or secures the intermediate meat in place over the cavity and the base meat.

The outer meat 30 may be any meat, but is preferably a type of bacon 30. However, it is appreciated that combinations or a plurality of outer meats may be used, such as prosciutto, salami, pepperoni, ham, chip steak, chicken chip steak or pancetta.

The outer meat 30 is preferably wrapped around the intermediate meat 18 and the base meat 10, in a manner that substantially covers and/or encases the intermediate meat 18 and the base meat 10. It is preferred that the outer meat 30 is wrapped circumferentially around the outer circumference of the generally cylindrical outer surface 11 of the base meat 10. The outer meat 30 may be, for example, individual slices of bacon 30 that are wrapped around the intermediate meat 18 and the base meat 10 in a helical, spiraling and/or overlapping fashion along a length of the intermediate meat 18 and the base meat 10, or wrapped so that the slice of bacon encircles a portion of the intermediate meat 18 and the base meat 10 that is about the width of the slice of bacon 30 that is being wrapped.

FIGS. 2A-2C generally illustrate the food product with the outer meat 30 first aligned along the length of the body 11 of the base meat 10 with the intermediate meat 18 shown facing outward from the Figure (FIG. 2A), then in the process of being wrapped around the intermediate meat 18 and base meat 10 (FIGS. 2B-2C), to encase the intermediate meat 18 and base meat 10.

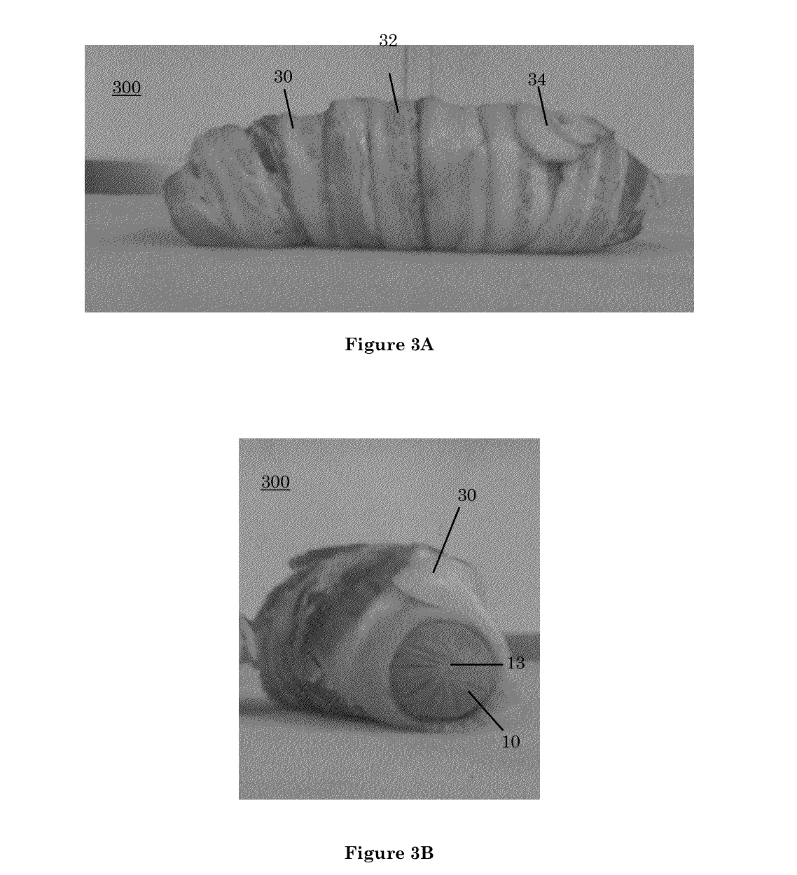

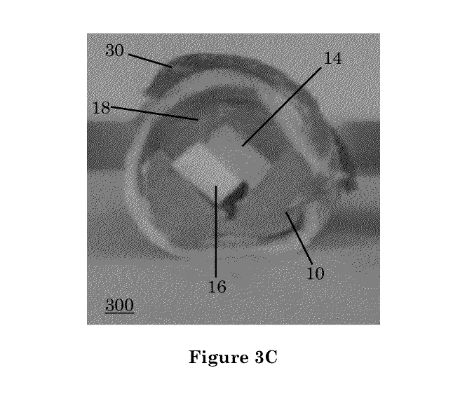

It is preferred that the outer meat 30 substantially covers and encloses the intermediate meat 18. It is preferred that the outer meat 30 substantially covers at least the outer surface of the generally cylindrical portion 11 of the base meat 10. As shown in the example illustrated in FIG. 3A, outer meat 30, second outer meat 32 and third outer meat 34 are wrapped in a manner that completely covers the intermediate meat 18 and the outer surface of at least the generally cylindrical portion 11 of the base meat 10. As shown in FIG. 3B, the outer meat may leave the ends 13, of the hot dog 10 slightly or mostly uncovered.

Examples of different combinations of the base meat 10, the intermediate meat 18 and the outer meat 30 are listed in Table 1 below.

TABLE 1
Example food product meat combinations.

| Base meat | Intermediate meat | Outer meat |
|---|---|---|
| Any | Chicken | Bacon, prosciutto, salami, pepperoni, ham, |
| hot dog | | chip steak, or pancetta. |
| | Steak | Bacon, prosciutto, salami, pepperoni, ham, |
| | | chicken chip steak, or pancetta. |
| Any | Chicken | Bacon, prosciutto, salami, pepperoni, ham, |
| bratwurst | | chip steak, or pancetta. |
| | Steak | Bacon, prosciutto, salami, pepperoni, ham, |
| | | chicken chip steak, or pancetta. |
| Any | Chicken | Bacon, prosciutto, salami, pepperoni, ham, |
| kielbasa | | chip steak, or pancetta. |
| | Steak | Bacon, prosciutto, salami, pepperoni, ham, |
| | | chicken chip steak, or pancetta. |
| Any | Chicken | Bacon, prosciutto, salami, pepperoni, ham, |
| sausage | | chip steak, or pancetta. |
| | Steak | Bacon, prosciutto, salami, pepperoni, ham, |
| | | chicken chip steak or pancetta. |
| Steak | Chicken | Bacon, prosciutto, salami, pepperoni, ham, |
| | | or pancetta. |
| | Any hot dog, any | Bacon, prosciutto, salami, pepperoni, ham, |
| | bratwurst, any | pancetta, or chicken chip steak. |
| | kielbasa, or | |
| | any sausage | |
| Chicken | Any hot dog, any | Bacon, prosciutto, salami, pepperoni, ham, |
| | bratwurst, any | pancetta, or chip steak. |
| | kielbasa, or | |
| | any sausage | |

Referring to FIG. 3A, a side view of food product 300 in an uncooked state is illustrated with outer meat 30, second outer meat 32 and third outer meat 34 shown, containing stick of cheese 14, stick of cheese 16, base meat 10 and intermediate meat 18 within. FIG. 3B is a perspective view of this arrangement, from an end of the food product 300.

Referring to FIG. 3C, a cross-section view of food product 300 is illustrated with stick of cheese 14 and stick of cheese 16 positioned at least partially within cavity 12 of base meat 10, with the cavity of base meat 10 and the cheeses 14, 16 covered by intermediate meat 18. The outer meat 30 is wrapped around base meat 10 and intermediate meat 18.

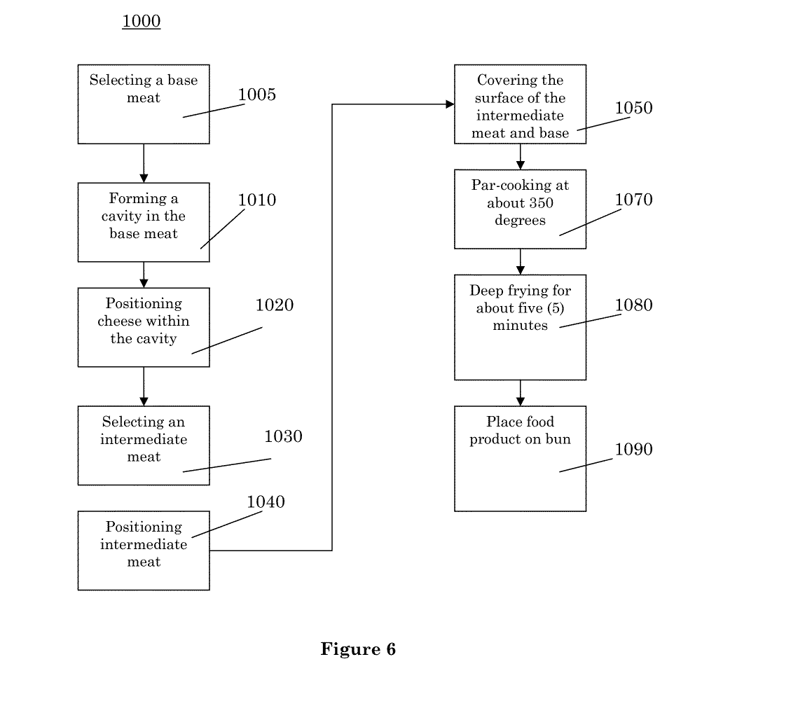

A method of making a food product of the present invention is also provided. FIG. 6 schematically represents steps for a method of making a food product according to the present invention. A method of making a food product 1000 is illustrated with steps of selecting a base meat 1005, forming a cavity in a base meat 1010, positioning at least one piece of cheese at least partially within the cavity 1020, selecting an intermediate meat 1030, positioning the intermediate meat over the cavity and the base meat to thereby cover the cavity, and intermediate meat and substantially cover the base meat 1050.

Additional preparation steps may include preheating an oven to 350 degrees 1060, placing the food product in the oven and par-cooking the food product at about 350 degrees F. 1070, and placing the food product in a deep fryer for approximately five (5) minutes to crisp the outer meat 1080. Finally, the food product may be placed on a bread (bun) for serving 1090. It is appreciated that the cooking temperature could be anywhere between a range of about 100 degrees F. to about 500 degrees F. without departing from the present invention, and other temperatures and cook times may also be used to cook the product.

In an embodiment of a method of making a food product according to the invention, a cavity is formed in a base meat. The cavity may preferably be formed by slicing open the base meat, or by any other acceptable method for creating a cavity in a meat product. For example, rather than providing a slice in the base meat, a chunk or a portion of the base meat may be cut and/or removed. Or, a cavity can be formed by boring a hole in the base meat. Additionally, if the base meat is a meat that can be shaped, the base meat may be preformed having a cavity in it.

Next, at least one piece of cheese is positioned in the cavity. Preferably, a stick of cheese is used. The stick of cheese may be placed inside the cavity. Although in a preferred embodiment a stick of cheese may be used, chunks or pieces of cheese may also be used to fill the cavity. If a soft cheese is used, the soft cheese may be squirted, sprayed, spread, injected, squeezed or otherwise deposited into the cavity. Several pieces of cheese may also be used, depending on preference.

Next, an intermediate meat is selected that is appropriate for covering the cavity. Selecting the intermediate meat may include selecting the intermediate meat for an appropriate thickness that permits the intermediate meat to be sized and/or shaped to be placed over and cover the cavity.

Next, the intermediate meat is positioned over the base meat and the cavity in order to substantially cover the cavity. Positioning the intermediate meat may include placing the intermediate meat on top of the base meat. Preferably, the intermediate meat completely covers the cavity.

Next, the surface of the base meat and the intermediate meat is covered with an outer meat 30. Covering the surface may include wrapping one or multiple pieces of the outer meat around the base meat and the intermediate meat. Referring to FIG. 2B, starting at one of the ends 13, 15, the outer meat 30 is placed around the base meat 10 and the intermediate meat 18, and the base meat 10 and the intermediate meat 18 are rolled to begin the encasement. The outer meat 30 is wrapped around ⅓ of the base meat 10 and the intermediate meat 18. Referring to FIG. 2C, second outer meat 32 starts at the point where the outer meat 30 ends, wrapping the next ⅓ of the base meat 10 and the intermediate meat 18. Referring to FIG. 3A, third outer meat 34 starts at the point where the second outer meat 32 ends, wrapping the last ⅓ of the base meat 10 and the intermediate meat 18. It is preferred that the outer meat 30 is not “stretched out” or pulled as it is being wrapped, but instead simply rolled around the base meat 10 and the intermediate meat 18 in order to keep its same or “natural” length in its uncooked form. A single long strand of an outer meat may be used to wrap the intermediate meat and base meat.

The method of making a food product further preferably includes cooking the food product in an oven. The food product, once formed, is preferably placed in an over heated to 350 degrees and par-cooked. Cooking may include twenty (20) minutes at 350 degrees Fahrenheit in an oven. Cooking may include heating any of the base meat, the intermediate meat or the outer meat to an appropriate internal temperature. It is preferred that the food product is cooked until the intermediate meat is substantially cooked. For example, where the intermediate meat is chicken, the chicken should be cooked to an internal temperature of 170 degrees Fahrenheit. It is appreciated that other temperatures and times may be used to accomplish cooking the food product of the present invention to an acceptable degree.

A method of making a food product preferably further includes frying the food product after it has been cooked as described. Frying the food product may be accomplished placing the entire formed, food product in a deep fryer. Preferably, this takes place for about 5 minutes. The food product is preferably deep fried until the outer meat reaches a desired crispiness. It is appreciated that the food product may be fried for any amount of time and at any temperature that fries the outer meat to a desired crispiness.

Referring to FIG. 4A, a cooked and then fried food product 400 is illustrated with outer meat 30, second outer meat 32 and third outer meat 34 shown, containing stick of cheese 14, stick of cheese 16, base meat 10 and intermediate meat 18 within. Referring to FIG. 4B, an end view of cooked, then fried food product 400 is illustrated with base meat 10, end 13 and outer meat 30. Referring to FIG. 4C, a cross-section view of cooked, then fried food product 400 is illustrated with stick of cheese 14 and stick of cheese 16 between base meat 10 and intermediate meat 18, with outer meat 30 wrapped around base meat 10 and intermediate meat 18.

Referring to FIG. 5A, an inner cross-section view of cooked, then fried food product 400 is illustrated with outer meat 30, second outer meat 32 and third outer meat 34 surrounding base meat 10 and intermediate meat 18, with stick of cheese 14 and stick of cheese 16 contained in between base meat 10 and intermediate meat 18. Cooking, then frying food product 400 caused stick of cheese 14 and stick of cheese 16 to melt and fully fill cavity 12.

The method of making a food product may include adding a sauce to the outer meat. The sauce may be any sauce. The sauce may be buffalo sauce or bar-b-q sauce.

The method of making a food product may include an additional step of placing the food product in a bread, such as, for example, a bun, torpedo roll, sandwich roll, “hero” roll or hoagie roll. Referring to FIG. 5B, cooked, then fried food product 400 is illustrated with bread 70 containing outer meat 30, second outer meat 32 and third outer meat 34, which contain stick of cheese 14, stick of cheese 16, base meat 10 and intermediate meat 18 within.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A food product comprising:
a base meat having a cavity formed therein to receive at least one piece of cheese;
at least one piece of cheese positioned at least partially within the cavity;
an intermediate meat, the intermediate meat having a selected thickness, the intermediate meat sized and configured to substantially cover the cavity in order to maintain the at least one piece of cheese at least partially within the cavity; and
an outer meat, the outer meat wrapped around the outer portion of the base meat and the intermediate meat, the outer meat substantially covering the base meat and the intermediate meat.

2. The food product of claim 1, wherein the at least one piece of cheese comprises a stick of cheese.

3. The food product of claim 1, wherein at least half of the at least one piece of cheese is positioned within the cavity.

4. The food product of claim 1, wherein the intermediate meat is in contact with the base meat along a contact zone adjacent the cavity.

5. The food product of claim 1, wherein the base meat is selected from a group consisting of a hot dog, a sausage and a bratwurst.

6. The food product of claim 1, wherein the intermediate meat comprises chicken.

7. The food product of claim 1, wherein the outer meat is selected from a group consisting of bacon, ham and prosciutto.

8. A method of making a food product comprising:
forming a cavity in a base meat, the cavity sized to receive at least one piece of cheese;
positioning at least one piece of cheese within the cavity;
selecting an intermediate meat, the intermediate meat sized to substantially cover the cavity in order to maintain the cheese within the cavity;
positioning the intermediate meat over the base meat and the cavity in order to substantially cover the cavity; and,
covering the entirety of the intermediate meat and at least a portion of the base meat with a outer meat.

9. The method of claim 8, wherein the at least one piece of cheese comprises a stick of cheese.

10. The method of claim 8, wherein at least one half of the at least one piece of cheese is positioned within the cavity.

11. The method of claim 8, wherein the intermediate meat is in contact with the base meat along a contact zone adjacent to the cavity.

12. The method of claim 8, wherein the base meat is selected from a group consisting of a hot dog, a sausage and a bratwurst.

13. The method of claim 8, wherein the intermediate meat comprises chicken.

14. The method of claim 8, wherein the outer meat is selected from a group consisting of bacon, ham and prosciutto.

15. The method of claim 8, further comprising cooking the food product.

16. The method of claim 15, further comprising frying the food product.
